(19) United States
(12) Patent Application Publication
(10) Pub. No.: US 2004/0052533 A1
(43) Pub. Date: Mar. 18, 2004

(54) System and method for noise suppression in optical communication

(76) Inventors: Zhan He, Chappaqua, NY (US); Jianfeng Li, Boulder, CO (US); Sadeg M. Faris, Pleasantville, NY (US)

Correspondence Address: Reveo, Inc., 85 Executive Blvd., Elmsford, NY, 10523, US

(21) Appl. No.: 10/453,857

(22) Filed: Jun. 3, 2003

Related U.S. Application Data
(63) Continuation-in-part of application No. 09/896,508, filed on Jun. 29, 2001.
(60) Provisional application No. 60/385,372, filed on Jun. 3, 2002.

(51) Int. Cl. H04B 10/18

(52) U.S. Cl. 398/158; 398/31

(57) ABSTRACT

A system and method is provided for optical communication in which the common noises can be significantly suppressed. The system includes two transmitters working at two different wavelengths. One transmitter is configured to encode information into an optical carrier signal, and another transmitter configured to transmit a reference signal, and a receiver device with two photo-detectors and differential detection to regenerate the information from the received optical signals.

### RELATED APPLICATIONS

The present application is a Continuation in Part of U.S. patent application Ser. No. 09/896,508 entitled “System and Method For Wavelength Modulated Free Space Optical Communication” filed on Jun. 29, 2001, and claims priority to U.S. Provisional Patent Application No. 60/385,372 entitled “System and Method for Noise Suppression in Optical Communication” filed Jun. 3, 2002, which are both incorporated by reference herein.

### BACKGROUND OF THE INVENTION

(1) Field of the Invention

The present invention generally relates to noise suppression in optical communications, and more particularly to common noise rejection for optical communications.

(2) Background Information

The advent of Internet multimedia applications such as Internet video conferencing and downloadable digital video has substantially increased communication bandwidth requirements. As a result, interest in optical fiber-based communication, particularly in dense wavelength division multiplexing (DWDM) technology, has increased significantly in recent years (see for example U.S. Pat. No. 6,043,914 to Cook et al., which is fully incorporated herein by reference). Fiber optic communication provides greatly increased bandwidths as compared to conventional copper wire technology. Optic fiber network has dominated more than 90% of the long haul traffic.

However, the cost to deploy the similar optic fiber networks in metro areas is often prohibitively high, and also the process is time-consumption. It can take 4-12 months and typically $100,000 to $150,000 per building to deploy fiber cable to a building less than 500 feet from the fiber backbone. According to a survey, in North American, existing optic fiber networks has covered less than 5% city areas. Therefore, the so-called “last-mile or first-mile” bottleneck has severely restricted the deployment of high capacity, high speed and high bandwidth communications.

There are several other approaches to address this “connectivity bottleneck,” but most don't make economic sense. The first one is radio frequency (RF) technology. RF is a mature technology that can offer wireless connection. However, RF-based networks require immense capital investments to acquire spectrum license. Also, RF technologies cannot scale up to higher capacities such as 2.5 Gbps. The current RF bandwidth ceiling is 622 Mbps, which does not make economic sense for service providers looking to extend optical networks. The second alternative is wire- and copper-based technologies, (i.e. cable modem, Tls or DSL). Although copper infrastructure is available almost everywhere and the percentage of buildings connected to copper is much higher than fiber, it is still not a viable alternative for solving the connectivity bottleneck because of the bandwidth scalability (only 2 to 3 Mbps).

One of the solutions for such kinds of applications is fiberless (also referred to as wireless) optical communication (FOC) or free-space optical (FSO) communication. For example, Terabeam Networks®, Inc. (2300 Seventh Ave., Seattle, Wash.), Airfiber®, Inc. (16510 Via Esprillo, San Diego, Calif.), Lightpointe® Communications, Inc. (10140 Barnes Canyon Rd., San Diego, Calif.), and Oraccess, Inc. (17 Shmidmann St. Briei Brak 51429 ISRAEL) provide a “free space optics” (FSO), fiberless solution to the well known “last-mile bottleneck” to a user's premises.

However, the above referenced technologies, no matter the fiber or fiberless optical communications, are potentially disadvantageous in that they rely on standard amplitude modulation (AM) encoding techniques. In optic fiber communications, esp. for long-haul networks, the power loss in the long distance connection could be very large due to attenuations in all components it passes through. Also, there may be some noise sources existing in the networks such as some optical amplifiers, which could create some noises into the signals. As a result, the signal-to-noise ratio (SNR) becomes very low at receivers. The fiberless optical communication technologies may be more sensitive to changes in weather conditions (e.g. wind, fog, rain or snow) that result in variations in optical intensity and may cause data loss or even data interruption. For example, in digital optical communication, light having a relatively high intensity commonly corresponds to a logical ‘1’ while light having a relatively low intensity commonly corresponds to a logical ‘0’. Optical intensity variations (e.g., caused by weather changes) may result in data loss (e.g., missed or erroneous bits) in the event the light intensity is not sufficiently high to register a logical ‘1’, or in the event background ‘noise’ is intense enough to obscure the logical ‘0’ and erroneously register a ‘1’ instead. This kind of noise may be timely variable and sometimes could be very strong.

In addition to the noises described before, the dark current and thermal noise generated at the photo-detectors could further reduce the SNR low. For FOC technologies, the ambient light from other light sources such as Sun would significantly reduce the dynamical range of the receiver devices.

Therefore, there exists a need to suppress the noises and improve the SNR in the optical communication system to overcome at least one of the aforementioned difficulties.

### SUMMARY OF THE INVENTION

In one aspect, the present invention includes an optical communication system including two transmitters working at two close, different wavelengths, the first transmitter configured to encode signal and transmit it through the network, and the second transmitter generates a reference signal and send it thought the same network. A receiver device is composed of two photo-detectors, one receives the light signal from the first transmitter and another is used to receive the light signal from the second transmitter. A differential detection is applied to decode the information by comparing the signal and the reference signal. Since the two beams experience similar noise loading in their paths, the common noises created in the network system can be rejected, which can re-generate a very high SNR signal. Moreover, when the two photo-detectors are designed onto a chip or placed very close to each other after the same fabrication process, the dark current and thermal noises from the photo-detectors can be dramatically reduced. Furthermore, the wavelength pairs used in this invention should not be considered only in the optical communication range, which could extend to all wavelengths.

In another aspect, this invention includes multiple transmitters, one of those transmitter is used to transmit a reference signal, and others configured to encode and transmit signals comprising information into optical carrier signals, and also includes multiple differential detecting receivers, each configured to decode the information from the optical carrier signals by comparing the information signals with the received reference signal.

In another aspect, this invention includes multiple transmitters, some of transmitters are used to encode and transmit signals comprising information and others are used to send the reference signal beams, and includes multiple differential detecting receivers to decode the information by comparing the information signals with the reference signals.

The system further includes multiple user ports, each including at least one of the multiple transmitters, multiple receivers, multiple hubs, each configured for transmitting and receiving data with at least two of the multiple user ports, and multiple repeaters each configured to receive, amplify, and route the optical signal to at least one member of the group consisting of other repeaters, hubs, and user ports.

In yet another aspect, this invention includes a common noise suppression method for optical communication. The method includes (i) encoding a first signal comprising information into an optical carrier signal and a second signal comprising a reference signal, (ii) transmitting the information, (iii) receiving the information, and (iv) decoding the information from the optical carrier signal by comparing the received reference signal. In one variation of this aspect, the method further includes multiplexing the first and second signals into a single beam and demultiplexing the single beam into multiple signals, each corresponding to a discrete carrier signal or a reference signal.

### BRIEF DESCRIPTION OF THE DRAWINGS

FIG. 1 is a schematic representation of a system for noise suppressed optical communication according to the principles of this invention;

FIG. 2 is representative plot of a system for noise suppressed optical communication;

FIG. 3 is a representative plot of original optical signals versus time at the two differential wavelengths illustrating the embodiment of FIG. 2;

FIG. 4 is a representative plot of received optical signals with noises versus time at the two differential wavelengths illustrating one variation of the embodiment of FIG. 2;

FIG. 5 is a representative plot of re-generated optical signals versus time after differential detection illustrating one variation of the embodiment of FIG. 2;

FIG. 6 is a schematic representation of the wavelength range that can be used for optical communication in the present invention.

FIG. 7 is a schematic representation of the wavelength pair switch ability of the present invention.

### DETAILED DESCRIPTION

The present invention relates to a novel noise suppression method for optical communication. An exemplary method of this invention, referred to herein as wavelength modulated optical communication (WMOC), includes encoding the information to be communicated on at least two discrete optical carrier signals, in which each carrier signal includes a carrier wavelength.

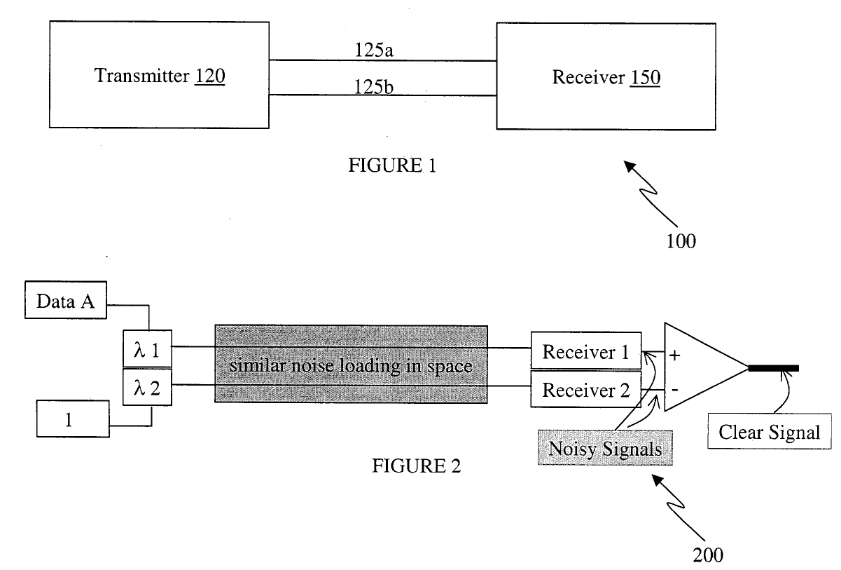

Referring to FIG. 1, a general block diagram of one embodiment of a system 100 according to the principles of this invention is illustrated. System 100 includes one or more transmitters 120 configured to transmit a first signal 125a comprising information encoded into an optical carrier signal and a second signal 125b comprising a reference signal. System 100 further includes a receiver device 150 configured to receive and decode the transmitted infornation 125a, 125b. As described in parent application Ser. No. 09/896,508 filed on Jun. 29, 2001, the second signal 125b may comprise, in embodiments described therein, information encoded into an optical carrier signal different from the first signal 125a.

The transmitted optical signal 125a, 125b, may include two or more beams (e.g., one for an information carrier signal and one for the reference signal).

The receiver device 150 is configured to receive and decode the information from the optical carrier signal 125a and is also configured to receive the received reference signal 125b. A differential detection, electric amplifier and other necessary electric circuits are also includes in the device 150.

Referring now to FIG. 2, a schematic depiction of a system 200 is provided. Two wavelength (λ1 and λ2) lights carry data signal A and noise probing signal 1. The two beams pass through the same light path, which experiences the same attenuation variations or noises. In fiber optic communication, a multiplexer is used to couple the two beams together and the mixed beam is sent into the optic fiber. A wavelength splitter (e.g., a DMUX device), not shown, is used to separate the two signals into the different receivers Receiver 1 and Receiver 2. In fiberless optical communication, a similar scheme as that in fiber optic communication can be used. In addition, two beams could be arranged very close to each other at the transmitter end and sent to the air. At the receiver end, a wavelength splitter (e.g., a DMUX device), not shown, is used to separate the two signals into the different receivers Receiver 1 and Receiver 2. Since the noises generated in the system are similar in the two beams, a differential detection can re-generate the original signal with maximum noise reduction.

The present invention is advantageous in that it provides for extremely high bandwidth fiberless optical communications across a broad band of carrier wavelengths (generally in the range from about 300 to about 10,000 nm, preferably about 700 nm to about 1,700 nm). Further, this invention may make use of conventional DWDM technology and may provide for a large number of broadband data transporting channels (e.g. 100 or more). Further still, this invention provides for improved stability and data reliability in FOCs in adverse weather conditions such as wind, fog, rain and/or snow. Furthermore, this invention may provide for highly secure data transmission and also provide a solution for the well-known “last-mile” bottleneck. Yet still further, this invention is advantageous in that it is compatible with conventional amplitude modulation optical communication.

As stated above, the method of the present invention includes encoding a first signal comprising information into an optical carrier signal and a second signal comprising a reference signal such as a flat signal. This is in contrast to conventional coherent optical communication. Coherent communications systems require at least two single-frequency lasers, one at the transmitter and one at the receiver. With this arrangement, modulated light from the transmitting laser can be heterodyned (or homodyned) with the brighter light from the receiver's laser, which is called a local oscillator. The difference between the coherent detection and this invention is obvious. The two beams from the transmitters are sent thought the optical communication system, not like what the coherent detection utilizes: one at transmitter end and another at the receiver end. The invented technology is a kind of direct detection with differential detection to reject the common noises. Therefore, the invented technology is simpler and easier to be performed than the coherent detection. Due to the simple and ease of this technology, the cost is low. Moreover, the reference laser does not require highly stable at the frequency and no polarization consideration is needed.

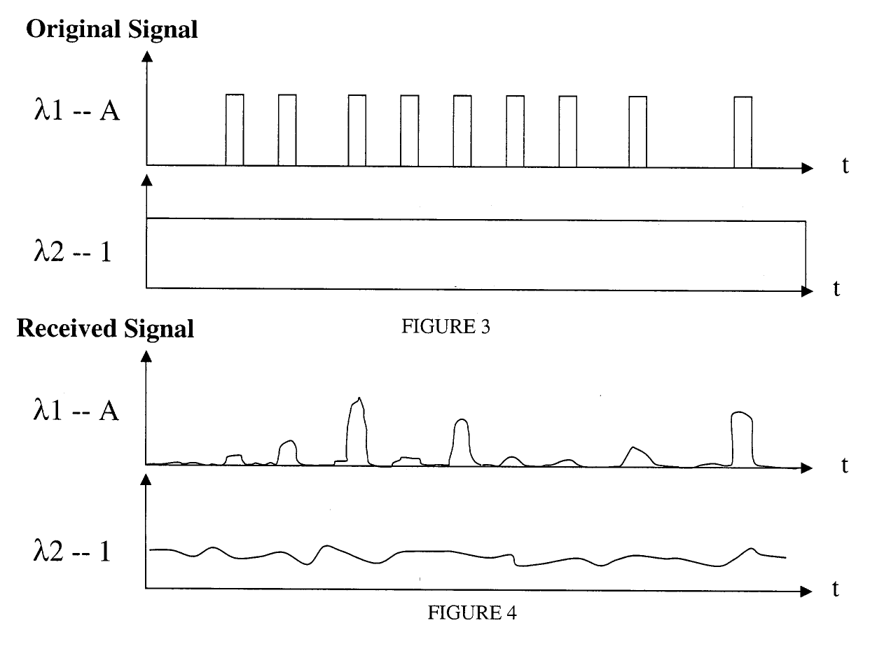

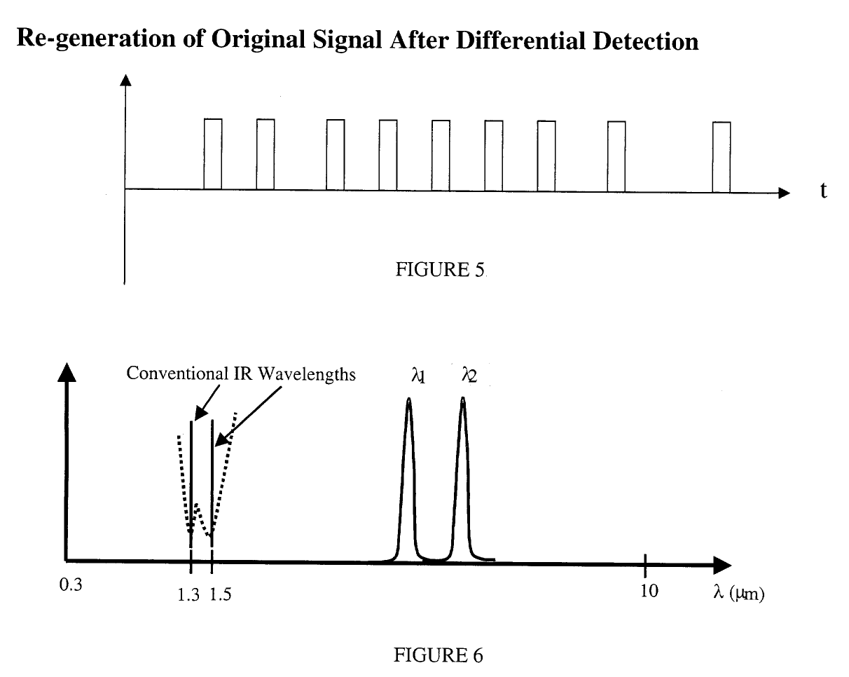

Referring now to FIGS. 3-5, a representation of one embodiment of transmission of a data signal and a reference signal, receipt of the data signal and the reference signal, and regeneration of the data signal is illustrated. FIGS. 3-4 show of original and received optical intensities on the ordinate axis and time on the abscissa axis for wavelengths λ1 and λ2, respectively, and FIG. 5 shows of optical intensity on the ordinate axis and time on the abscissa axis for regenerated signal. Wavelength, λ1, encodes a logical ‘1’ or a logical ‘0’, while another wavelength, λ2 represents a constant reference signal, as an example. Upon receiving the beams, the electric signals generated from the two wavelength light beams are performed differential detection to produce a binary data stream (i.e., the “1”'s or “0”'s). The common noises in the two beams are rejected. The artisan of ordinary skill in the art will readily recognize that the carrier wavelengths λ1 and λ2 may be multiplexed into a single beam at the transmitter side and demultiplexed into its individual carrier wavelengths at the receiver side. Moreover, the skilled artisan will also recognize that substantially any modulation techniques may be used to encode digital information into carrier wavelength λ1, without departing from the spirit and scope of the present invention.

As shown in FIG. 6 (not in scale), which is a representative plot of wavelength range, the method of this invention is not restricted to utilizing infrared (IR) wavelengths (e.g., approximately 1310 or 1550 nanometers), which, as mentioned hereinabove, are used in conventional fiber optic technology. Instead, the wavelengths used in the present invention may range from about 300 to more than about 10,000 nanometers, esp. for fiberless optical communications.

Further, the present invention may be combined with conventional WDM or DWDM technology (or yet to be developed multiplexing and/or demultiplexing technology) to provide for extremely wide bandwidth and/or data rate communications. The transmitter may include any of numerous well known multiplexing components (referred to herein as MUX) for multiplexing the optical carrier signals. The receiver may including any of numerous well known demultiplexing components (referred to herein as DEMUX) for demultiplexing the optical carrier signals. Multiplexing and demultiplexing technologies are well known in the art and are, therefore, not discussed in detail herein. In one embodiment the optical carrier signal and the reference signal may be multiplexed into a single optical beam.

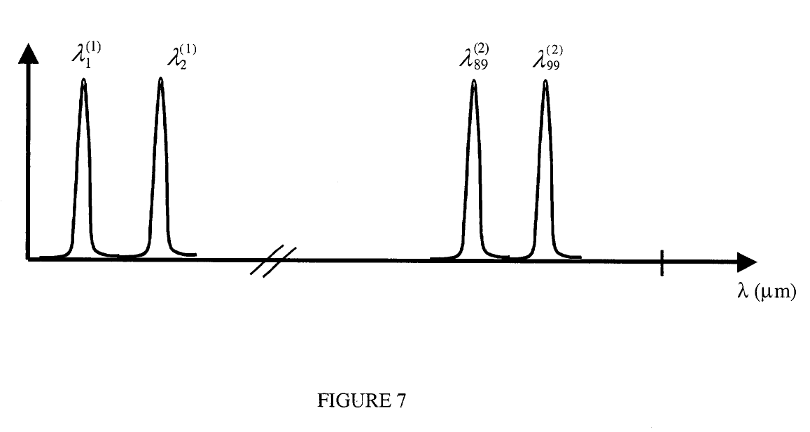

Moreover, alternate embodiments of the present invention may include switching (i.e. changing) the carrier and reference wavelength pair to wavelengths that are less sensitive to particular weather conditions (e.g., the wavelength pair may be switched to longer wavelengths). For example, as shown in FIG. 7, the wavelengths may be changed from λ1 and λ2 to λ89 and λ99 upon the onset of adverse atmospheric conditions or even upon the forecast thereof.

Furthermore, the wavelength pairs (λ1 and λ2) may be changed following a programmable protocol to provide for increased security. The protocols may be previously determined or communicated to the receiver in real time by control bits embedded in the data stream. It shall be understood that those of ordinary skill in the art will readily conceive of numerous schemes for changing the wavelength pairs.

The modifications to the various aspects of the present invention described hereinabove are merely exemplary. It is understood that other modifications to the illustrative embodiments will readily occur to persons with ordinary skill in the art. All such modifications and variations are deemed to be within the scope and spirit of the present invention as defined by the accompanying claims.

What is claimed is:

1. A noise suppressed optical communication system comprising:
two transmitters, one configured to encode the information in an optical carrier signal and another configured a reference signal; and
a receiver device with two photo-detectors configured to receive and decode the information from said optical carrier signal and the reference signal by differential detection.

2. The system of claim 1 wherein said discrete optical carrier signal includes information corresponding to logical 1's or logical 0's. Also, the optical signal could be analog.

3. The system of claim 1,
said transmitter being configured to communicate a logical 1 or a logical 0 by modulating the optical amplitude at a first carrier wavelength and to communicate a reference by transmitting a constant optical signal at a second carrier wavelength.

4. The system of claim 1 wherein said transmitter comprises at least one multiplexer to multiplex said optical signals.

5. The system of claim 4 wherein said receiver comprises at least one demultiplexer to demultiplex said optical signals.

6. The system of claim 1 wherein each of said optical signals comprises a carrier wavelength in the range of about 300 to about 10,000 nanometers.

7. The system of claim 6 wherein each of said optical signals comprises a carrier wavelength in the range of about 700 to about 1,700 nanometers.

8. The system of claim 1 wherein said transmitter is configured to change a carrier wavelength of at least said optical carrier signal.

9. The system of claim 1 wherein said transmitter is configured to change the carrier wavelength of said optical carrier signal in a programmed manner to increase the security.

10. A noise suppressed optical communication comprising:
multiple transmitters each configured to encode information into an optical carrier signal and transmit a reference signal;
multiple receivers each configured to receive and decode the information from said optical carrier signal and the reference signal; and
multiple user ports, each including at least one of said multiple receivers.

11. A method for noise suppressed optical communication of information comprising:
encoding the information into an optical carrier signal;
transmitting said encoded carrier signal;
transmitting a reference signal;
receiving said encoded carrier signal;
receiving said reference signal; and
decoding the information from said signals by differential detection.

12. The method of claim 11 wherein said encoding comprises encoding digital information or analog information.

13. The method of claim 12 wherein said encoding digital information comprises encoding a high/low amplitude optical pulse at a first carrier wavelength to correspond to a logical 1 or a logical 0, and determining noise from the reference signal.

14. The method of claim 11 further comprising:
multiplexing said optical signals into a single beam; and
demultiplexing the single beam into said carrier signal and said reference signal.
